(19) United States
(12) Patent Application Publication
(10) Pub. No.: US 2015/0371120 A1
(43) Pub. Date: Dec. 24, 2015

(54) VISUAL AXIS OPTIMIZATION FOR ENHANCED READABILITY AND COMPREHENSION

(71) Applicant: Sarfaraz K. Niazi, Deerfield, IL (US)

(72) Inventor: Sarfaraz K. Niazi, Deerfield, IL (US)

(21) Appl. No.: 14/308,462

(22) Filed: Jun. 18, 2014

(51) Int. Cl. G06K 15/02; G06F 3/14; G06T 3/60; G06F 3/01

(52) U.S. Cl. CPC G06K 15/1867; G06F 3/013; G06F 3/1431; G06T 3/60

(57) ABSTRACT

While the printed text is vertically aligned at 90 degrees, the visual axis of the reader is not aligned with the printed or displayed axis of text resulting in difficulties in readability and comprehension of text and images that can be obviated by printing or displaying text and images at an angle to align with the axis of the eye.

### BACKGROUND OF THE INVENTION

The Sumerians invented writing with words about five thousand years ago (c. 3100 BC). As far as it is known, it derived from symbols used for the keeping of accounts around four hundred years earlier. Sumer was located in what is now Southern Iraq. At first, writing was restricted to inscriptions, e.g. on stone, seals, brooches, and containers. The Sumerians then developed baked clay tablets, which can be regarded as the first books. The papyrus rolls of the Egyptians, made from a plant native only to the Nile Valley, soon followed these. From around 500 BC the papyrus roll became dominant, although clay tablets survived for another five hundred years or so. Temporary records could be kept on wooden tablets hollowed out and filled with a wax coating. Students, merchants and others could write on the wax, then erase their markings and reuse the surface. These tablets could be connected in groups, which formed a model for the later codex book.

The traditional modern form of the book is called the codex. It has multiple separate leaves of pages, bound between protective covers. This format has been with us for about nineteen hundred years (from around the second century AD). Within two hundred years of its introduction the codex became dominant. The codex book (plural=codices) has survived so long because it has many unique advantages.

The first codex books used either papyrus or parchment as the writing surface. Parchment was made from animal skin and gradually became preferred to papyrus for the codex, as it was more suitable for the new format. By the 7th century AD, parchment had almost replaced papyrus altogether in Europe and the Middle East, and remained the preferred medium in Europe for about 800 years longer.

The disappearance of papyrus use was hastened by the near extinction of the papyrus plant, caused by foolish over harvesting. Parchment use did not seem impractical, since books were rare items hand-copied in only very limited quantities. Another, more expensive writing material was vellum, a higher quality variety of parchment made at first only from calfskin.

Meanwhile paper was invented in China as early as 105 AD, and was at first prepared from bark and hemp. This paper developed to a high standard, and papermaking later spread to Japan (c. 610 AD), and then to the Arab world along the Silk Road, via Samarkand in Central Asia. Pre-Columbian American civilizations also produced a more primitive bark paper from an unknown date.

The Arabs introduced paper into Europe via Spain. However it was not actually made in Europe until around 1276 AD (in Italy), and not in England until 1495. One reason for this slow advance was that European-style paper, made usually from flax and hemp, was at first inferior to parchment, especially for illustrations. So until it was improved, paper was not very suitable for the style of illustrated manuscript common in the West.

Printing was another Chinese invention. The first known book not written by hand was printed in what is now China in the ninth century AD, from engraved wooden blocks. Because Chinese writing was in the form of a very large number of pictographs, moveable type was of little advantage. However such cast type did appear in Korea before developing quite independently in Europe.

A major advance in the West was Johannes Gutenberg's printing from cast metal type (c. 1450 AD). However this was still hand composed on a mostly wooden press.

The next great change was slow to arrive, being the metal printing press developed by Lord Charles Stanhope in 1803. This still relied on human power to operate, however. A steam-powered press invented by the German Friedrich Koenig followed in 1810. An American, Richard Hoe, invented the faster rotary press in 1846. Printing raced further ahead when the mechanical composition of type was perfected in 1886 with the Linotype compositor.

Lithography was long used to print pictures for books. From this method came the idea for offset printing, and the first offset press appeared in 1904. In offset printing a smooth photographic plate replaces the method of “relief” printing from cast metal type, traditional since Gutenberg; the latter prints indirectly through a reverse image on a rubberized cylinder. By 1980 offset printing was taking over from the older method in many countries.

That was only the beginning of the modern printing revolution. From 1968 computers became involved in printing (the Linotron). In 1983 the offset plate progressed to a format involving the laser-beam transference of stored digital information. Gradually, printing worldwide became a digital and computerized process, and mechanical printing began to disappear. This change led to the reality that a series of advanced digital electronic processes now produced the traditional analogue material book. It was only a matter of time before the logical conclusion would be drawn - that books could exist in a purely electronic form.

Moreover, such books could incorporate new possibilities undreamed of in the printed codex book. For example, they could be instantly updated, be searchable electronically, include sounds & video and even a dictionary, and interact directly with the new Internet, and therefore contain instant links to further information.

The advent of digital book files also meant that traditional physical books could now be printed individually, as required, from a stored computer file (Print on Demand, or POD), rather than in the traditional large print runs. This meant that “out of print” books could now be made available again within hours, and indeed that the whole concept of “out of print” titles could be abolished over time. As well, it now became financially practicable to print less popular books in limited numbers where before they were uneconomic to print at all.

So rather than immediately displacing the printed codex, the advent of the digital book meant that the physical book could now flourish as never before. At the same time this change prepared the ground for a decisive future shift towards electronic reading (remember for example that clay tablets survived into the era of papyrus rolls for around five hundred years).

The electronic book or e-book (also spelled ebook and eBook) began to emerge in its own right in the last years of the twentieth century, existing as a virtual entity stored in a digital file. Like many new technologies it suffered from technical teething troubles, ineffective or inappropriate marketing, commercial rivalries that slowed its progress, and initial public skepticism or indifference.

Gradually however the electronic book became capable of being easily read from a wide variety of devices, and its vast potential began to be more widely understood. It became clear that the e-book would represent the next leap forward in the onward march of the book. While it can simply represent traditional texts and thus replicate all existing literature, the e-book can also become a layered and interactive multimedia experience. Indeed, a single reader or group could even spontaneously assemble the book of the future from multiple sources for specific educational or entertainment purposes. The e-book therefore holds the promise of adding an unprecedented degree of flexibility to the concept of the book.

The book is one of humanity's most enduring cultural artifacts and treasures. As it evolves, the greatest threat to its future is therefore not from technical advances but from the danger of new generations losing the inclination to read. The ability to read and write is our greatest tool in education, and, apart from the family, the single most important medium existing for the transmission of ideas and the continuance of an evolving human culture.

The craft of bookbinding probably originated in India, where religious sutras were copied on to palm leaves (cut into two, lengthwise) with a metal stylus. The leaf was then dried and rubbed with ink, which would form a stain in the wound. The finished leaves were given numbers, and two long twines were threaded through each end through wooden boards, making a palm-leaf book. When the book was closed, the excess twine would be wrapped around the boards to protect the manuscript leaves.

Codices were a significant improvement over papyrus or vellum scrolls in that they were easier to handle. However, despite allowing writing on both sides of the leaves, they were still foliated—numbered on the leaves, like the Indian books. Western books from the fifth century onwards were bound between hard covers, with pages made from parchment folded and sewn on to strong cords or ligaments that were attached to wooden boards and covered with leather. Since early books were exclusively handwritten on handmade materials, sizes and styles varied considerably, and there was no standard of uniformity. Early and medieval codices were bound with flat spines, and it was not until the fifteenth century that books began to have the rounded spines associated with hardcovers today. Because the vellum of early books would react to humidity by swelling, causing the book to take on a characteristic wedge shape, the wooden covers of medieval books were often secured with straps or clasps. These straps, along with metal bosses on the book's covers to keep it raised off the surface that it rests on, are collectively known as furniture.

### BRIEF SUMMARY OF THE INVENTION

Modern book printing follows the style developed a long time ago, a book bound at the spine with left and right pages. However, as we open the book, holding in front of our face, we are inevitably forced to turn our head to left or to right to read what is on the left of the right page, unless we are folding it and reading it as a single page placed aligned with the axis or our eyes. FIG. 1 shows the alignment of our eye axis with text on the left and right pages showing that the horizontal axis of the eye aligns only in the middle of the spine of the book. FIG. 2 shows the misalignment of the printed or displayed text and the axis of our eyes regardless of whether we are reading the left page of the right page. Whereas we may have become used to such reading style over years, this is not a natural scanning format of our eyes that are more capable of aligning objects vertically or horizontally. The prior art is silent on any suggestions to remove this misalignment of the axis of the eye and the axis of the printed or displayed matter. There is therefore a need to invent a method to provide this alignment to improve the readability and through that perhaps comprehension of the printed or displayed matter.

### BRIEF DESCRIPTION OF THE OF THE DRAWINGS

FIG. 1 depicts the misalignment of the eye axis with the traditionally printed or electronically displayed text on the left and right pages.

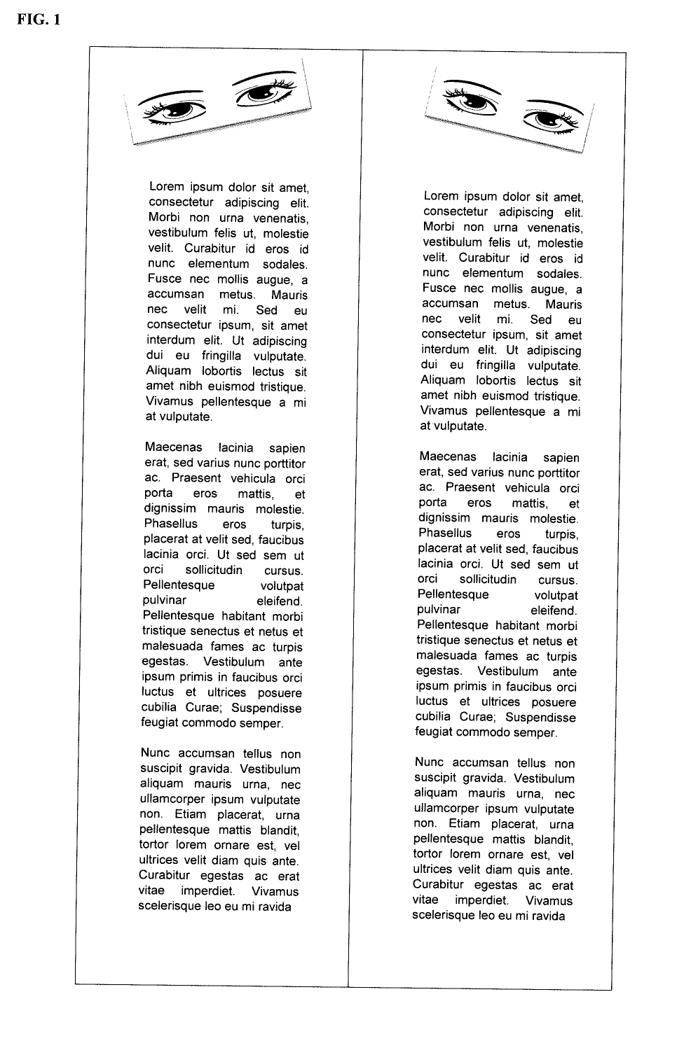

FIG. 2 depicts the alignment of the eye axis with rotated printed or electronically displayed text on the left and right pages.

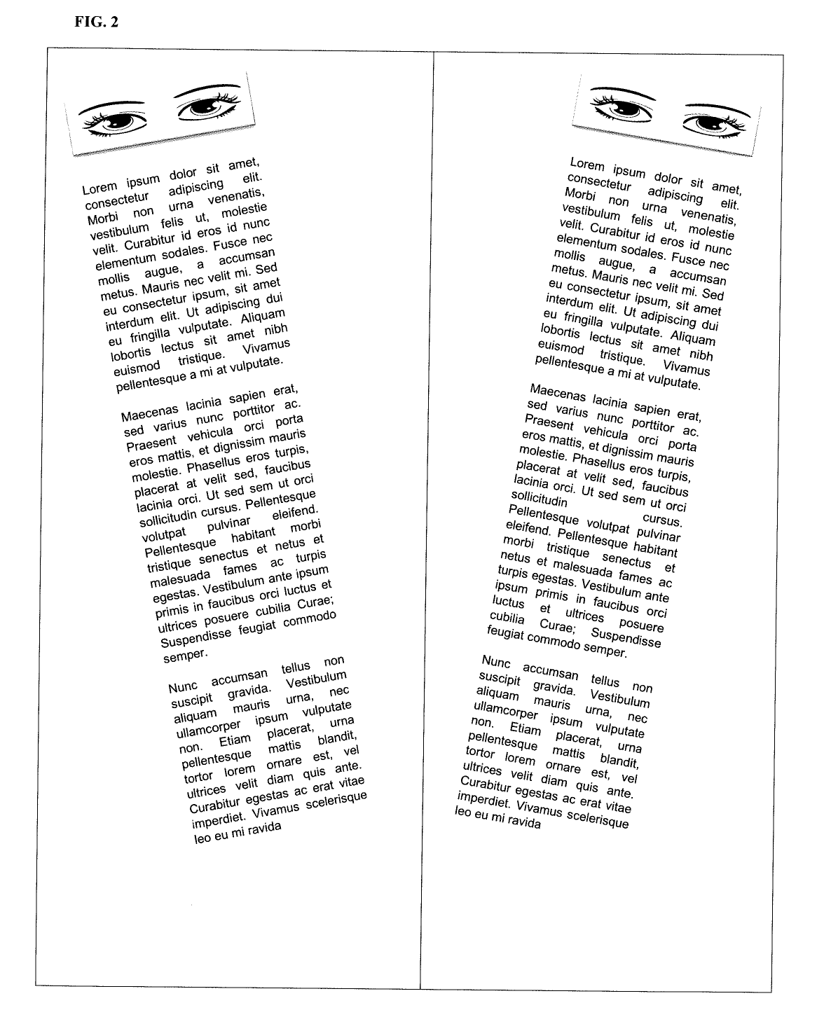

### DETAILED DESCRIPTION OF THE INVENTION

Generally, books have left and right pages, which are invariably printed straight on a vertical axis. The human eyes form a horizontal axis and when the face is rotated towards the left or the right page, the horizontal axis of the eyes is no longer aligned with the vertical axis creating a situation where the eyes scan the text not in alignment with eyes. While most of us have been trained to read this misaligned text, this exercise inevitably creates a stress on the visual apparatus. Removing this stress is likely to improve the readability of the text, the speed of reading and above all, comprehension of the text—all of which will add to the productivity and efficiency of the reader. One aspect of the stress in reading can result in aversion to reading, a phenomenon widely observed at all ages. Removing the stress in reading can reduce the aversion and thus increase literacy and wider use of books. More particularly, this may help children starting to read when they have not yet accustomed to accommodating this stress in reading.

The stress in reading from accommodating to align the text with the axis of the eye may also result in various physiological phenomenon such as headaches, and other outcomes that may have kept many from being fluent in reading books.

The extent of misalignment of the horizontal axis of the eye and the vertical axis of the text in a book depends on how far is the book held from the eyes. At a greater distance, this misalignment may be minimal but the recommended distance of about nine inches to 24 inches, this is significant. The closer is the book held to the eyes, the greater is the misalignment. Contrary to the popular belief, reading a book keeping it closer to the eye of reading in the dim light does not affect the eyes, in fact, it strengthens the muscles of the eye that control the eyes lens; this old wives tale has been deeply embedded in our culture.

Man evolved into an enlightened species by recording the thoughts and the history in written forms that allowed the generations of mankind to benefit from the wisdom and the experiences of the previous generations. Today, we are able to read and hopefully understand what Socrates and Plato said thousands of years ago; today, we are able to appreciate the impact the religious books like Ramayana, Torah, Bible and Qur'an have had on the history of mankind. There are books that turned the course of mankind and there are books that brought mankind to its lowest ebb. Such is the power of books. However, book reading has not always been as well adopted, as it should have been. There are bookworms who would read anything and everything and then there are those who have never opened a book. While most of these differences in the aptitude and the attitude of the people can be attributed to many causes, one of the cause that has never been recognized is the stress that reading a text misaligned to the axis of the eye may produce.

Reading a misaligned text is deeply embedded in our training. There is no prior art that suggests that this misalignment is of any importance; we have accepted the book design to be fundamental and published billions of books using this format. There is therefore a need to correct this historic misunderstanding in our physiologic responses to reading text.

Today, we live in an age of electronics; and the classical book printed on paper seems threatened by the culture of e-books. No one can be the best judge of predicting the future of books; would we abandon the books printed on the paper? Would we be a generation of bytes for all time to come? I cannot answer this question, for this is a question of posterity. A few decades from today, we may have an answer. However, given the popularity of the e-books, I do not have any doubt that these will constitute a significant majority of the reading; our new generation of children, growing in the electronic generation, while the older generation may still find solace in feeling and smelling a printed text. Regardless of where we end up, and I am predicting it will be mostly electronic, the problem of text misaligned with the axis of the eye remains. Yes, we can tilt the device to suit it better to align, but seldom do it, as we are used to the style of reading the books. Fortunately, the electronic systems allow us many self-adjusting opportunities. For example, the technology available today can read our eye axis through a set of cameras pointing to our eyes and then adjusting the angle of the text on the displayed screen we tilt our face. This will allow a continuous alignment of the text; this quite analogous to the automatic focusing of the image allowed in the cameras. The technology of face movement and recognition is coming of age and the new models of Mercedes Benz will allow the driver to control the functions of the cars through the facial expressions.

The electronic devices also allow us the freedom to modulate the angle of the displayed text at an angle that we find most comforting and suitable. In an electronic control system wherein the image of text is continuously aligned to our eye axis will indeed be most effective in achieving the goals of this invention.

Whereas the degree of alignment of the presented text is determined by the axis of the eyes, in most instances, this will not vary more than a few degrees as we tilt our face towards the left and the right page. However, some may choose to tile their face to extreme degree and to accommodate that the range of the text alignment, whether in print or electronic display must comport with this tilt. Generally, in a printed text this will range from one degree to about twenty degrees but in the electronic media, it may he totally controlled by the axis of the eye.

How far can the text be rotated is limited by the dimension of the book of the displayed text; since the dimension of the field is fixed, rotation of text beyond a certain limit will make if impossible for the text to display in the lower part of the page. One way to increase the visibility while increasing the tilt is to reduce the font size allowing more text to be displayed; ideally, the alignment will be limited to complete lines of text displayed when the text is rotated on the left of the right axis. As a result, the extent of alignment will depend on the margins allowed in the text display. This is further limited by the minimum margins required for the printing of the text. If, for example, the printing bleed required is about a quarter of inches and the text is formatted for one inch margins, there is only a ¾ inch adjustment that is available to change the rotation of the text. To keep the readability, this may well be the limiting condition of the text margin in the printed and the displayed text.

In electronic media systems where an e-reader may only present one page at a time, the constraints of misalignment are reduced but not eliminated altogether. We are used to holding the devices at different angles and a system of instantly aligning the vertical axis of the displayed text and the horizontal axis of the eye can be very useful resulting in a text display that is continuously aligned to the best reading position of the text.

The instant invention provides a means of aligning the text to the visual axis and whereas it is presented primarily for the readable text, this can be extended to any text of image displayed on a screen or a display; for example, the same theory as described here for the text can be applied to television screens and other display format.

In a preferred embodiment of the invention, the text is printed on the left page at an angle less than 90 degrees and the text on the right page is printed at more than 90 degrees.

In a second embodiment, the text on the right and the left pages is rotated to a degree ranging from 0.5 to 90 degrees. The angle of text on the left page is ideally between 45 and 89 degrees and between 91 and 134 degrees on the right page.

In a third embodiment, the text is rotated corresponding to the axis of the eye in an electronic reading system such as an e-book, where cameras installed in the e-book monitor the axis of the eye.

In a fourth embodiment, the text is rotated in an electronic media with a control mechanism provided to the reader to adjust it to the most comfortable reading position.

In a fifth embodiment, the text is displayed on a media an electronic screen such as television, movie screen or any display.

What is claimed is:

1. A method of improving readability and comprehension of text and images comprising printing or displaying the text and images at an angle to align with the horizontal axis of the eyes of the reader.

2. The method of improving readability and comprehension of text and images of claim 1, wherein the text and images are printed or displayed at an angle of less than 90 degrees on the left page and at an angle of greater than 90 degrees on the right page.

3. The method of improving readability and comprehension of text and images claim 1, wherein the text and images are printed or displayed at an angle of 45 to 89 degrees on the left page and 91 to 135 degrees on the right page.

4. The method of improving readability and comprehension of text and images of claim 1, wherein the text and images are printed on a material surface.

5. The method of method of reducing improving readability and comprehension of text and images of claim 4, wherein the text and images are part of a book, magazine, brochure or unbound pages.

6. The method of improving readability and comprehension of text and images of claim 4, wherein the text and images appear on paper, plastic, wood, metal or rubber surface.

7. The method of improving readability and comprehension of text and images claim 4, wherein the material surface is flexible.

8. The method of improving readability and comprehension of text and images of claim 1, wherein the text and images appear in an electronic display or a television.

9. The method of improving readability and comprehension of text and images of claim 8, wherein the electronic display is a component of a book reader, a computer, an entertainment device or a hand-held device.

10. The method of improving readability and comprehension of text and images of claim 8, wherein the angle of the text and images is adjusted by a controller mechanism operated by the reader.

11. The method of improving readability and comprehension of text and images of claim 8, wherein the angle of the text and images is adjusted automatically by a sensor that tracks the axis of the eye and changes the angle of the text and images in the electronic display.
